(19) United States
(12) Patent Application Publication
(10) Pub. No.: US 2020/0322731 A1
(43) Pub. Date: Oct. 8, 2020

(54) ACOUSTIC TRANSDUCER

(71) Applicant: Merry Electronics(Shenzhen) Co., Ltd., ShenZhen (CN)

(72) Inventors: Jen-Yi Chen, Taichung (TW); Chao-Sen Chang, Taichung (TW); Yung-Hsiang Chang, Taichung (TW)

(73) Assignee: Merry Electronics(Shenzhen) Co., Ltd., ShenZhen (CN)

(21) Appl. No.: 16/909,973

(22) Filed: Jun. 23, 2020

Related U.S. Application Data
(63) Continuation-in-part of application No. 15/604,670, filed on May 25, 2017.
Application No. 15/604,670 is a continuation of application No. 14/056,221, filed on Oct. 17, 2013, now abandoned.

(51) Int. Cl. H04R 19/00; H04R 7/06

(52) U.S. Cl. CPC H04R 19/005; H04R 19/04; H04R 7/06

(57) ABSTRACT

An acoustic transducer includes a base plate, a vibrating membrane and a back plate. The vibrating membrane covers an opening of the base plate and has a plurality of conjoint vibratile portions and a plurality of elastic structures. The elastic structures are concentrically arranged along peripheries of the vibratile portions. The acoustic transducer further has a connecting portion extending from the back plate to a boundary between each two of the adjacent vibratile portions so as to allow the vibratile portions to generate vibration independently. The elastic structures include a first elastic structure and a second elastic structures arranged alongside of the boundary, and a third elastic structure arranged along an outer periphery of the vibrating membrane. The vibratile portions are geometrically different from each other and different in rigidity, and the vibratile portions can vibrate independently to respond to various sound pressure levels.

### CROSS-REFERENCE TO RELATED APPLICATION

This application is a continuation-in-part application of and claims the priority benefit of U.S. application Ser. No. 15/604,670, filed on May 25, 2017, now pending. The prior application Ser. No. 15/604,670 claims the priority benefit of U.S. application Ser. No. 14/056,221, filed on Oct. 17, 2013, now abandoned. The entirety of each of the above-mentioned patent applications is hereby incorporated by reference herein and made a part of this specification.

### BACKGROUND OF THE INVENTION

### 1. Technical Field

The present invention relates to acoustic transducers used in MEMS microphones, and more particularly to an acoustic transducer having a single vibrating membrane that includes a plurality of vibratile portions, wherein the vibratile portions are configured to operate independently.

### 2. Description of Related Art

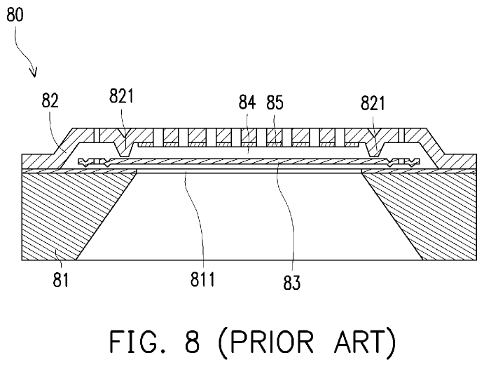

MEMS microphones are known to have advantages of being compact and easy to manufacture, so are extensively used in mobile phones. A conventional acoustic transducer 80, as shown in FIG. 8, has a base plate 81, a back plate 82 and a vibrating membrane 83. The vibrating membrane 83 covers an opening 811 of the base plate 81, and the back plate 82 is deposited on the base plate 81 and separated from the vibrating membrane 83 by an air gap 84. An electrode unit 85 is arranged on the back plate 82 and there is a fixing portion 821 that fixes an outer periphery of the vibrating membrane 83. The fixing portion 821 may be a hollow column or formed by a plurality of bulges arranged into a circle. Thereby, when the acoustic transducer 80 receives an acoustic wave, the vibrating membrane 83 vibrates and changes its distance from the electrode unit 85, causing change of capacitance.

However, with the development of smartphones that support video shooting and similar functions, the demand for compact microphones with high acoustical quality have been grown increasingly. Particularly, acoustic transducers are expected to maintain a certain good degree of sensitivity and signal-to-noise ratio when receiving sounds of various sound pressure levels (SPLs). The dynamic range of a vibrating membrane in an acoustic transducer depends on various factors, such as the material and the dimensions of the vibrating membrane of the vibrating membrane. For making an acoustic transducer responsive to different SPLs, it would be a relatively easy approach to geometrically modifying the vibrating membrane (e.g. width, thickness or area) during the manufacturing process while maintaining a certain good degree of sensitivity and signal-to-noise ratio. When the objective is to enhance the dynamic range of an acoustic transducer for its receipt of sounds, it generally needs plural vibrating membranes. However, for saving the material and minimizing the size of microphone, such vibrating membranes of different dimensions can though be traditionally assembled together, but they are subject to interference with each other. Thus, it has been a challenge for designers of acoustic transducers to simply enhance the dynamic range of the acoustic transducer without increasing the total area of the vibrating membrane while maintaining a certain good degree of sensitivity and signal-to-noise ratio.

### BRIEF SUMMARY OF THE INVENTION

In an embodiment, an acoustic transducer including a base plate, a single vibrating membrane and a back plate is provided. The single vibrating membrane is disposed above the base plate and includes an inner vibratile portion, an outer vibratile portion, a plurality of elastic structures, and a boundary between the inner vibratile portion and the outer vibratile portion, and an outer periphery, wherein. The inner vibratile portion and the outer vibratile portion are conjoint, the outer vibratile portion encircles the inner vibratile portion, and the outer periphery encircles the outer vibratile portion. The plurality of elastic structures is concentrically arranged along peripheries of the inner vibratile portion and the outer vibratile portion. The back plate includes a connecting portion extending from the back plate to the boundary of the single vibrating membrane. The plurality of elastic structures includes a first elastic structure arranged along the periphery of the inner vibratile portion adjacent to the boundary, a second elastic structure arranged along the periphery of the outer vibratile portion adjacent to the boundary, and a third elastic structure arranged along the periphery of the outer vibratile portion away from the boundary. The inner vibratile portion and outer vibratile portion are different in rigidity, and the inner vibratile portion and the outer vibratile portion vibrate independently to respond to various sound pressure levels.

In another embodiment, an acoustic transducer including a base plate, a single vibrating membrane, a back plate, an elastic portion, a plurality of electrode units, and a connecting portion is provided. The base plate has a square opening. The single vibrating membrane is disposed on the base plate to cover the square opening and includes a plurality of rectangular vibratile portions that are conjoint, a plurality of elastic structures arranged along peripheries of the rectangular vibratile portions, a boundary between any two of the plurality of rectangular vibratile portions adjacent each other, and an outer periphery that encircles the rectangular vibratile portions. The back plate fixes the outer periphery of the single vibrating membrane onto the base plate. The electrode units are disposed on a surface of the back plate, and the electrode units are distributed respectively above all the rectangular vibratile portions. The connecting portion extends from the back plate to the boundary of the single vibrating membrane. The plurality of elastic structures includes a first rectangular elastic structure arranged at one side of the boundary and a second rectangular elastic structure arranged at an opposite side of the boundary. The rectangular vibratile portions are geometrically different from each other, the rectangular vibratile portions are different in rigidity, and the rectangular vibratile portions vibrate independently to generate variations of capacitance between the rectangular vibratile portions and the electrode units.

BRIEF DESCRIPTION OF THE SEVERAL VIEWS OF THE DRAWINGS

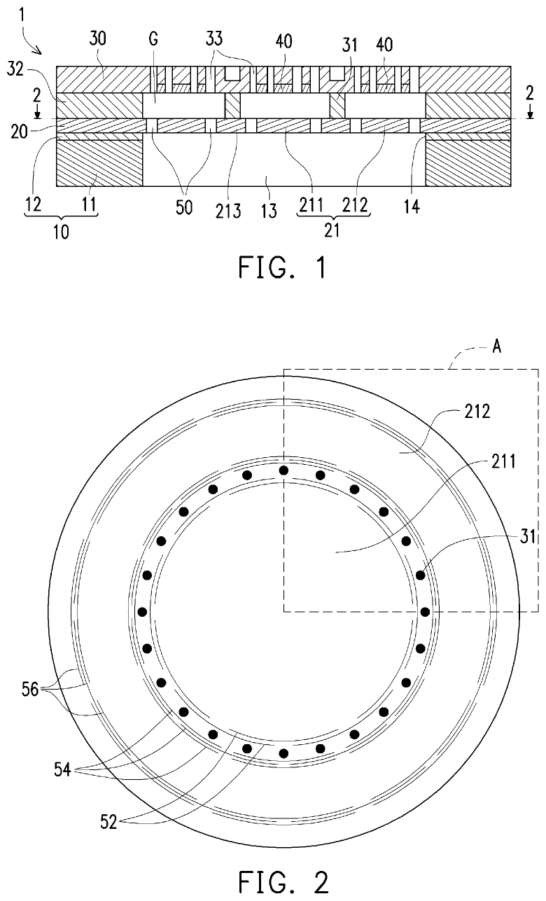

FIG. 1 is a transverse cross-sectional view of an acoustic transducer according to a first embodiment of the present invention.

FIG. 2 is a vertical cross-sectional view of the acoustic transducer according to the first embodiment of the present invention taken along Line 2-2 in FIG. 1.

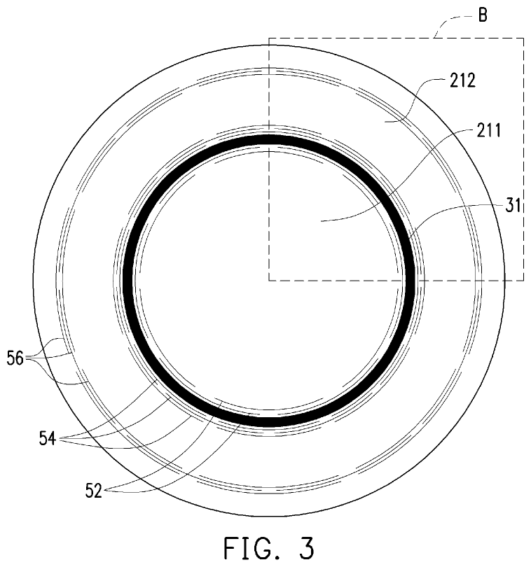

FIG. 3 is another cross-sectional view of the acoustic transducer according to the first embodiment of the present invention, showing the connecting portion is a hollow column.

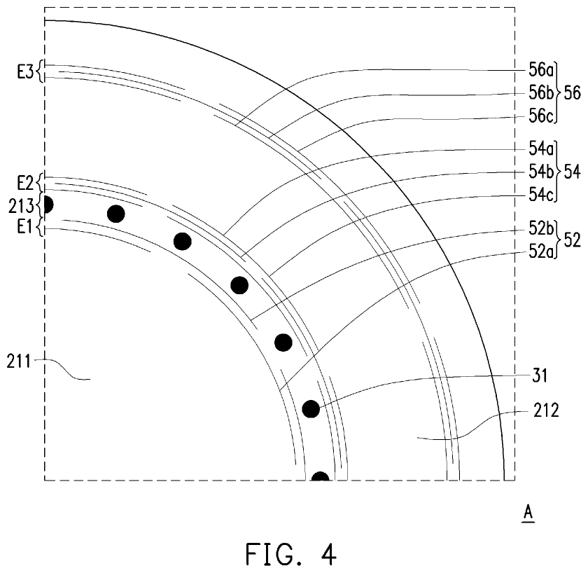

FIG. 4 is a partial enlarged cross-sectional view of the acoustic transducer shown in a region A of FIG. 2.

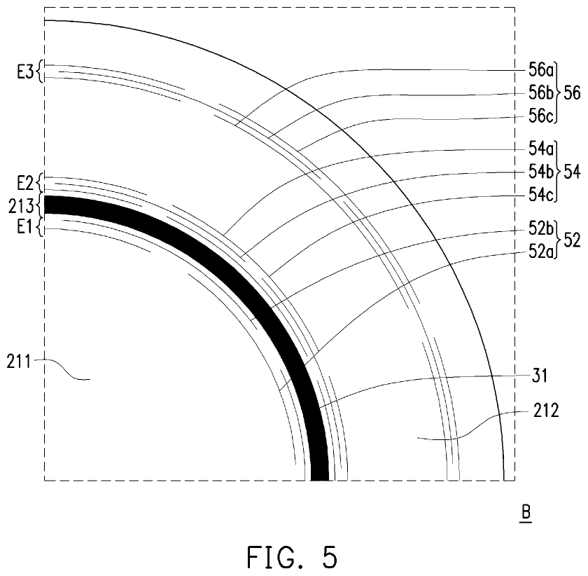

FIG. 5 is a partial enlarged cross-sectional view of the acoustic transducer shown in a region B of FIG. 3.

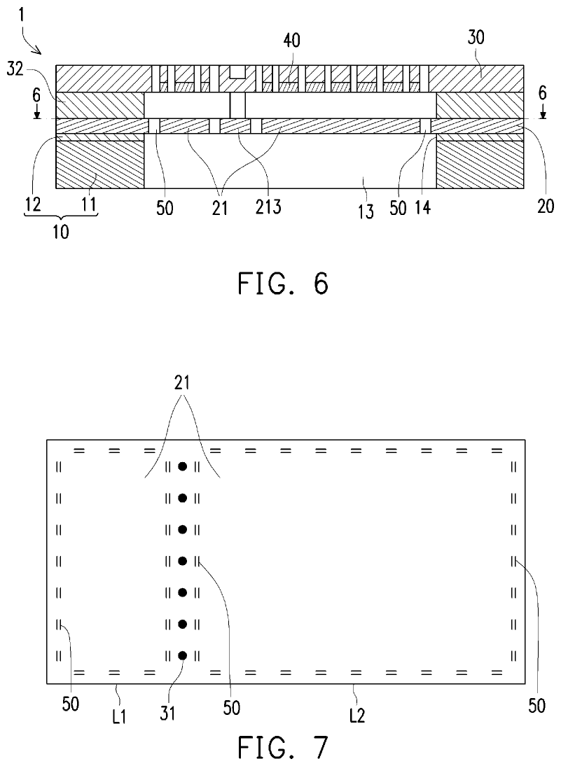

FIG. 6 is a cross-sectional view of an acoustic transducer according to a second embodiment of the present invention.

FIG. 7 is another cross-sectional view of the acoustic transducer of FIG. 5 taken along a sectional line 6-6.

FIG. 8 is a cross-sectional view of a conventional acoustic transducer.

### DETAILED DESCRIPTION OF THE INVENTION

For further illustrating the features of the present invention, the following description, in conjunction with the accompanying drawings and preferred embodiments, is set forth as below. Referring to FIG. 1 through FIG. 5, according to a first embodiment of the present invention, an acoustic transducer 1 mainly comprises a base plate 10, a vibrating membrane 20 and a back plate 30. The structure and configuration of the components are described in the following sections.

As shown in FIG. 1, the base plate 10 is formed by a silicon bottom layer 11 and an insulation layer 12 deposited on the silicon bottom layer 11. The base plate 10 has a hollowed portion 13 extending between two sides of the base plate 10 and forming a round opening 14 at the insulation layer 12 for acoustic waves to pass therethrough.

The vibrating membrane 20 is disposed on the base plate 10 and covers the opening 14. The vibrating membrane 20 has a plurality of vibratile portions 21 that are conjoint. In the present embodiment, the vibrating membrane 20 is round and the vibratile portions 21 are provided in an amount of two, including a round inner vibratile portion 211 and a ring-like outer vibratile portion 212 that encircles the outer periphery of the inner vibratile portion 211. The inner vibratile portion 211 and outer vibratile portion 212 have a substantially even thickness and include different geometric shapes.

It is to be noted that the inner vibratile portion 211 and the outer vibratile portion 212 are not limited to the combination of round and ring-like shapes, and may alternatively be a combination of a rectangular portion and a round-outside square-inside ring, or a different geometric combination. Also, the opening 14 is not necessarily to be round, and may be square or of another shape.

The back plate 30 is covered on the base plate 10 from above, so that an air gap G is formed between the back plate 30 and the base plate 10. The back plate 30 has a connecting portion 31, which extends from a bottom surface of the back plate 30 toward a top surface of the vibrating membrane 20, and is connected to the boundary between the inner vibratile portion 211 and the outer vibratile portion 212. In the present embodiment, the connecting portion 31 comprises a plurality of columns arranged along the boundary between the inner vibratile portion 211 and the outer vibratile portion 212 (as shown in FIG. 2). The connecting portion 31 may alternatively comprise a plurality of rectangular prisms, or a single hollow column (as shown in FIG. 3). Electrode units 40 are disposed on a back surface of the back plate 30, and the electrode units 40 are distributed respectively above the inner vibratile portion 211 and the outer vibratile portion 212. The back plate 30 further has a plurality of sound holes 33 for allowing acoustic waves to pass therethrough. The number of the sound holes 33 may vary according to practical needs. Depending on the means of packaging, the acoustic transducer 1 may have acoustic waves transmitted from the sound hole 33 to the vibrating membrane 20. In addition, while the outer periphery of the vibrating membrane 20 is firmly fixed to the base plate 10, in the present embodiment we further uses a fixing portion 32 to encircle and fix the outer periphery of the vibrating membrane 20 so as to make the connecting portion 31 connected to the back plate 30 and the vibrating membrane 20 more directly and more firmly. People skilled in the art can save the use of the fixing portion 32 or allow the two laterals of the back plate 30 to be connected with the base plate 10 directly, and the back plate 30 does not contact the vibrating membrane 20, as appropriate in view of practical needs.

Additionally, the connecting portion 31 in the first embodiment may alternatively extend from the vibrating membrane 20 toward the back plate 30 and is connected to the boundary between the inner vibratile portion 211 and the outer vibratile portion 212, with the same technical function achieved.

In response to acoustic waves passing through the hollowed portion 13 and reaching the vibrating membrane 20, the inner vibratile portion 211 and the outer vibratile portion 212 vibrate vertically with respect to the base plate 10, so as to change their distances from the electrode units 40 disposed on the back plate 30, thereby causing variations of capacitance. Since the connecting portion 31 connects the back plate 30 with the vibrating membrane 20 at the boundary between the inner vibratile portion 211 and the outer vibratile portion 212, the boundary between the inner vibratile portion 211 and the outer vibratile portion 212 constitutes a non-vibrating region 213 of the vibrating membrane 20, and the vibration of the inner vibratile portion 211 is prevented from being transmitted to the outer vibratile portion 212, and vice versa. Thereby, the inner vibratile portion 211 and the outer vibratile portion 212 can vertically vibrate independently without interfering with each other. Also, since the inner vibratile portion 211 and the outer vibratile portion 212 are substantially identical in terms of thickness, the rigidity of each of the vibratile portions 21 is determined by its geometry.

The vibratile portions 21 of different levels of rigidity respond to acoustic waves with different dynamic ranges. Therefore, a designer of an acoustic transducer can modulate the desired dynamic range by simply modifying the vibratile portions 21 geometrically while maintaining a certain good degree of sensitivity and signal-to-noise ratio.

In the embodiment as shown in either FIG. 2 or FIG. 3, since the inner vibratile portion 211 and the outer vibratile portion 212 include different geometric shapes, such that the inner vibratile portion 211 is a round inner vibratile portion and the outer vibratile portion 212 is a ring-like outer vibratile portion that encircles the round inner vibratile portion, the area of the inner vibratile portion 211 is smaller than the area of the outer vibratile portion 212. As such, the inner vibratile portion 211 has a rigidity level higher than and a sensitivity degree lower than that of the outer vibratile portion 212.

It is to be explained that the present invention involves dividing a single vibrating membrane 20 into the vibratile portions 21 that have different geometric shape, so the total area of the vibrating membrane 20 needs not to increase. Since the areas of the individual vibratile portions 21 are smaller than that of the original vibrating membrane, the vibratile portions 21 consequently have higher rigidity and lower sensitivity. For addressing this problem, the designer of the a acoustic transducer 1 may optionally include a plurality of elastic structures 50 in the vibrating membrane 20 along the periphery of each of the vibratile portions 21 so as to form different elastic regions, and make the elastic coefficient of the elastic region deforming toward the back plate 30 smaller than the elastic coefficient of the vibratile portion 21 deforming toward the back plate 30. By this way, the designer may have more flexibility in modulating the resulting dynamic range.

Referring to FIG. 2 and FIG. 3, the elastic structures 50 comprise a first elastic structure 52, a second elastic structure 54 and a third elastic structure 56 concentrically arranged along the peripheries of the vibratile portions 21. The difference between the acoustic transducer in FIG. 2 and acoustic transducer in FIG. 3 merely lies in the form of the connecting portion 31, but in either cases, the connecting portion 31 causes the formation of non-vibrating region at the site where the connecting portion 31 contacts the vibrating membrane 20.

In more detail, referring to either FIG. 4 or FIG. 5, FIG. 4 is a partial enlarged cross-sectional view of the acoustic transducer shown in a region A of FIG. 2, and FIG. 5 is a partial enlarged cross-sectional view of the acoustic transducer shown in a region B of FIG. 3. The first elastic structure 52 is arranged along the periphery of the inner vibratile portion 211, and forms a first elastic region E1 adjacent to the boundary between the inner vibratile portion 211 and the outer vibratile portion 212. The second elastic structure 54 is arranged along the inner periphery of the outer vibratile portion 212, and forms a second elastic region E2 adjacent to the boundary. The third elastic structure 56 is arranged along the outer periphery of the outer vibratile portion 212, and forms a third elastic region E3 adjacent to the fixing portion 32. The first elastic region E1, the second elastic region E2 and the third elastic region E3 are different regions of the vibrating membrane 20, and the first elastic region E1 and the second elastic region E2 are separated by the non-vibrating region 213.

More specifically, as shown in either FIG. 4 or FIG. 5, the first elastic structure 52 comprises a first set of concentric slits 52a and 52b, the second elastic structure 54 comprises a second set of concentric sits 54a, 54b and 54c, and the third elastic structure 56 comprises a third set of concentric slits 56a, 56b and 56c. The spacing between the first set of concentric slits 52a and 52b is greater than the spacing between the second set of concentric slits 54a, 54b and 54c and the spacing between the third set of concentric slits 56a, 56b and 56c. This allows the second and third elastic regions E2 and E3 to have a higher degree of elasticity than the first elastic region E1. In addition, since the concentric slits 54a and 54c in the second elastic region E2 and the concentric slits 56a and 56c in the third elastic region E3 have a same radian (namely, a same central angle) while the concentric slits 54b in the second elastic region E2 and the concentric slits 56b in the third elastic region E3 have a same radian (namely, a same central angle), such that the second set of concentric slits 54a, 54b and 54c and the third set of concentric slits 56a, 56b and 56c have an identical angular arrangement, the outer vibratile portion 212 can exhibit piston movement during vibration, such as vibrating vertically up and down. Further, due to the presence of the non-vibrating region 213, the outer vibratile portion 212 can vibrate independently without interfering the inner vibratile portion 211.

In the present embodiment, as the area of the inner vibratile portion 211 is smaller, with the arrangement of the first elastic structure 52 in the periphery of the inner vibratile portion 211, the inner vibratile portion 211 having the lower degree of sensitivity is suitable for sensing high sound pressure and thus can serve as a high sound pressure sensing region. Also, since the area of the outer vibratile portion 212 is greater, with the arrangements of the second elastic structure 54 and the third elastic structure 56 in the inner and outer peripheries of the outer vibratile portion 212, the outer vibratile portion 212 having the lower level of rigidity (e.g., higher elasticity), by performing the piston movement, is sensitive to sense low sound pressure and thus can serve as a low sound pressure sensing region. In addition, the designer of an acoustic transducer can adjust the structural arrangement and design of the elastic structures 52, 54 and 56 in the different elastic regions E1, E2 and E3, respectively, so as to further modulate the resulting dynamic range.

Furthermore, the scope of each of the vibratile portions 21 is defined by the site where the connecting portion 31 contacts the vibrating membrane 20 and by the connected part of the outer periphery of the vibrating membrane 20, so that each of the vibratile portions 21 can vibrate independently. In the present invention, the vibratile portions 21 are conjoint with each other to form a complete vibrating membrane 20. However, in a case where the boundary between the vibratile portions 21 comprises a physical interval, and all the peripheries of the vibratile portions 21 are fixed by the connecting portion 31 or partially fixed to the base plate 10 and partially fixed by the connecting portion 31, the vibratile portions 21 can also vibrate independently, and is also within the scope of the present invention.

In a second embodiment of the present invention, as shown in FIG. 6 and FIG. 7, an acoustic transducer 1 is structurally similar to the first embodiment except that the opening 14 is a square hole and the vibrating membrane 20 is rectangular. In this embodiment, the connecting portion 31 comprises a plurality of columns linearly arranged along the boundary between two rectangular vibratile portions 21 in a direction parallel to the width side W of the vibrating membrane 20. The electrode units 40 are disposed on a back surface of the back plate 30, and the electrode units 40 are distributed respectively above both the two rectangular vibratile portions 21. The elastic structures 50 include a first rectangular elastic structure arranged at one side of the boundary and a second rectangular elastic structure arranged at an opposite side of the boundary. The two rectangular vibratile portions 21 are substantially equal in terms of thickness but have different aspect ratios. Thereby, the designer of the acoustic transducer can modulate the desired dynamic range more easily by modifying side lengths (L1&L2) of the two rectangular vibratile portions 21.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. An acoustic transducer, comprising:
a base plate;
a single vibrating membrane disposed above the base plate and comprising an inner vibratile portion, an outer vibratile portion, a plurality of elastic structures, a boundary between the inner vibratile portion and the outer vibratile portion, and an outer periphery, the plurality of elastic structures being concentrically arranged along peripheries of the inner vibratile portion and the outer vibratile portion; and
a back plate comprising a connecting portion extending from the back plate to the boundary of the single vibrating membrane,
wherein plurality of elastic structures comprises a first elastic structure arranged along the periphery of the inner vibratile portion adjacent to the boundary, a second elastic structure arranged along the periphery of the outer vibratile portion adjacent to the boundary, and a third elastic structure arranged along the periphery of the outer vibratile portion away from the boundary.

2. The acoustic transducer of claim 1, wherein the inner vibratile portion and outer vibratile portion are different in rigidity, and the inner vibratile portion and the outer vibratile portion vibrate independently to respond to various sound pressure levels.

3. The acoustic transducer of claim 1, wherein the inner vibratile portion and the outer vibratile portion are conjoint, the outer vibratile portion encircles the inner vibratile portion, and the outer periphery encircles the outer vibratile portion.

4. The acoustic transducer of claim 1, wherein the inner vibratile portion is a round inner vibratile portion and the outer vibratile portion is a ring-like outer vibratile portion that encircles the round inner vibratile portion.

5. The acoustic transducer of claim 1, wherein the connecting portion comprises a plurality of separated solid columns arranged along the boundary between the inner vibratile portion and the outer vibratile portion.

6. The acoustic transducer of claim 1, wherein the connecting portion is a hollow column that covers the boundary between the inner vibratile portion and the outer vibratile portion.

7. The acoustic transducer of claim 1, wherein the inner vibratile portion and the outer vibratile portion are substantially identical in thickness.

8. The acoustic transducer of claim 1, wherein a distance from the first elastic portion to a concentric center of the plurality of the elastic portions is greater than a distance between the first elastic portion and the second elastic portion, and a distance between the third elastic portion and the second elastic portion is greater than the distance between the first elastic portion and the second elastic portion.

9. The acoustic transducer of claim 1, wherein the inner vibratile portion has a rigidity level higher than and a sensitivity degree lower than that of the outer vibratile portion.

10. The acoustic transducer of claim 1, further comprising at least two electrode units disposed on a surface of back plate, and at least two electrode units being distributed respectively above the inner vibratile portion and the outer vibratile portion.

11. The acoustic transducer of claim 1, wherein the boundary between the inner vibratile portion and the outer vibratile portion constitutes a non-vibrating region that is restricted to vibrate by the connecting portion.

12. The acoustic transducer of claim 11, wherein the first elastic structure and the second elastic structure are arranged alongside the non-vibrating region and separated by the non-vibrating region.

13. The acoustic transducer of claim 1, wherein the first elastic structure comprises a first set of concentric slits, the second elastic structure comprises a second set of concentric slits, the third elastic structure comprises a third set of concentric slits, and a spacing between the first set of concentric slits is greater than a spacing between the second set of concentric slits and a spacing between the third set of concentric slits.

14. The acoustic transducer of claim 13, wherein the second set of concentric slits and the third set of concentric slits have an identical angular arrangement, and the outer vibratile portion is configured to exhibit a piston movement during vibration.

15. The acoustic transducer of claim 1, wherein the inner vibratile portion is configured to serve as a high sound pressure sensing region and the outer vibratile portion is configured to serve as a low sound pressure sensing region.

16. An acoustic transducer, comprising:
a base plate having a square opening;
a single vibrating membrane disposed on the base plate to cover the square opening and comprising a plurality of rectangular vibratile portions that are conjoint, a plurality of elastic structures arranged along peripheries of the rectangular vibratile portions, a boundary between any two of the plurality of rectangular vibratile portions adjacent each other, and an outer periphery that encircles the plurality of rectangular vibratile portions;
a back plate, fixing the outer periphery of the single vibrating membrane onto the base plate;
a plurality of electrode units disposed on a surface of the back plate, and the plurality of electrode units being distributed respectively above all the plurality of rectangular vibratile portions; and
a connecting portion extending from the back plate to the boundary of the single vibrating membrane,
wherein plurality of elastic structures comprises a first rectangular elastic structure arranged at one side of the boundary and a second rectangular elastic structure arranged at an opposite side of the boundary,
wherein the plurality of rectangular vibratile portions are geometrically different from each other, the plurality of rectangular vibratile portions are different in rigidity, and the plurality of rectangular vibratile portions vibrate independently to generate variations of capacitance between the plurality of rectangular vibratile portions and the plurality of electrode units.

17. The acoustic transducer of claim 16, wherein the plurality of rectangular vibratile portions are disposed on the base plate to cover the square opening of the base plate jointly.

18. The acoustic transducer of claim 16, wherein the connecting portion comprises a plurality of separated solid columns arranged along the boundary between any two of the plurality of rectangular vibratile portions adjacent each other.

19. The acoustic transducer of claim 16, wherein the connecting portion is a hollow column that covers the boundary between any two of the plurality of rectangular vibratile portions adjacent each other.

20. The acoustic transducer of claim 16, wherein the boundary between any two of the plurality of rectangular vibratile portions adjacent each other constitutes a non-vibrating region fixed by the connecting portion, and the first rectangular elastic structure and the second rectangular elastic structure are arranged alongside the non-vibrating region and separated by the non-vibrating region.
